(19) United States
(12) Patent Application Publication
(10) Pub. No.: US 2017/0145315 A1
(43) Pub. Date: May 25, 2017

(54) APPARATUS FOR PREVENTING SPONTANEOUS IGNITION OF TRANSFERRED COAL IN APPARATUS FOR DRYING COAL USING REHEAT STEAM

(71) Applicant: HANKOOK TECHNOLOGY INC., Seoul (KR)

(72) Inventor: Sung Kon KIM, Anyang-si, Gyeonggi-do (KR)

(73) Assignee: HANKOOK TECHNOLOGY INC., Seoul (KR)

(21) Appl. No.: 15/320,261

(22) PCT Filed: Jun. 17, 2015
(86) PCT No.: PCT/KR2015/006145

§ 371 Date: Dec. 19, 2016

(30) Foreign Application Priority Data
Jun. 17, 2014 (KR) 10-2014-0073232
Jun. 17, 2014 (KR) 10-2014-0073236
Jan. 2, 2015 (KR) 10-2015-0000094

(51) Int. Cl. C10B 57/10; C10L 5/04; F26B 21/14; F26B 25/00; F26B 3/06; F26B 21/00

(52) U.S. Cl. CPC C10B 57/10; F26B 3/06; F26B 21/005; F26B 21/14; F26B 25/009; C10L 5/04; C10L 2290/08; C10L 2290/06; C10L 2290/148

(57) ABSTRACT

The present invention relates to an apparatus for preventing, in a multi-stage dryer for drying coal using reheat steam, spontaneous ignition caused by oxidation of coal when coal is transferred to the multi-stage dryer from a fixed quantity coal supplier by way of a pulverizer. The present invention relates to an apparatus for drying coal using reheat steam, the apparatus being configured so that coal which has been dried primarily in a first coal dryer is inputted into a second coal dryer and thus is secondarily dried, wherein reheat steam generated from a reheater is supplied through a reheat steam supply pipe; a nitrogen supplier supplies nitrogen through a nitrogen supply pipe; saturated steam generated from a saturated steam generator is supplied through a saturated steam supply pipe; the reheat steam supply pipe, the nitrogen supplier, and the saturated steam supply pipe are connected to a 4-way valve; and the 4-way valve supplies nitrogen and saturated steam, or nitrogen or saturated steam, along with reheat steam, to first to fourth steam chambers through the steam supply pipe, and injects steam into coal which is transferred to a first transfer plate and a second transfer plate so that spontaneous ignition of coal is prevented in the course of drying and transferring coal.

### TECHNICAL FIELD

The present invention relates to an apparatus for preventing spontaneous ignition of transferred coal for drying in an apparatus for drying coal using reheat steam and more particularly, to an apparatus for preventing, in a multi-stage dryer for drying coal using reheat steam, spontaneous ignition caused by oxidation of coal when coal is transferred to the multi-stage dryer from a fixed quantity coal supplier by way of a pulverizer.

### BACKGROUND ART

In general, a thermal power plant generating power by using coal as fuel combusts coal of approximately 180 ton/hr per 500 MW and supplies coal equivalent to approximately 37 ton per one pulverizer to a boiler. In the 500 MW thermal power plant using the coal, approximately 6 coal storages having a capacity of approximately 500 ton are installed and in 5 coal storages, the coal is normally supplied and one remaining coal storage is operated as a coal yard capable of reserving coal which may be preliminarily used during a predetermined period.

Moreover, in the thermal power plant using the coal as the fuel, a standard thermal power design criterion for the coal is designed to use low-moisture bituminous coal of 6,080 Kcal/Kg and 10% or less. In some thermal power plant, imported coal is used and some bituminous coal among the imported coal average moisture content of 17% or more may be provided to decrease combustion efficiency of the boiler. When a calorific value of coal using 5,400 Kcal/Kg as a standard thermal power combustion limit is low, it is anticipated that a power generation amount decreases and fuel consumption increases due to the decrease in combustion efficiency. Moreover, when subbituminous coal which is high-moisture low calorific coal is used, a moisture content is higher than a design criterion, and as a result, a transport system transporting the coal is not smooth and when the coal is pulverized by the pulverizer, efficiency decreases and the combustion efficiency decreases due to partial incomplete combustion, and unbalance of heat distribution, which occurs in the boiler and the boiler may also operate in an abnormal state. However, in the thermal power plant, a use weight of the subbituminous coal gradually increases up to approximately 41 to 60% in order to reduce fuel cost.

Further, preference to the thermal power plant increases due to anticipations of a global business recovery and confronting a safety problem due to breakage of a nuclear power plant by a big earthquake of Japan, and as a result, it is expected that the demand and cost of the coal will continuously increase. As an environment of a global coal market is changed from a consumer to a supplier, stable supply and demand of the coal are actually difficult and a yield of the high caloric coal is prospected to be maintained at a current level, and as a result, the unbalance of the supply and demand of the coal is anticipated.

The low caloric coal in total global coal deposits is approximately 47% and the deposits are large, but the caloric value is small and the moisture content is high, and as a result, it is difficult to completely combust the high-moisture low caloric coal due to a combustion failure, and the like during combustion. Therefore, the high-moisture low caloric coal is disregarded on the market. Globally, a tendency to depend on a stable price of petroleum and low-priced production cost of the nuclear power generation has been high in recent years, but construction of a lot of thermal power plants using the coal has been planned due to a rapid increase of a petroleum price and anxiety about the nuclear power generation in recent years.

As a technique (thermal drying) that dries the coal in the related art, a rotary drying method that dries coal particles in a cylindrical shell with high-temperature gas while rotating the cylindrical shell into which the coal is input, a flash (pneumatic) drying method that dries the coal by lifting the high-temperature dry gas from the bottom to the top while supplying the coal from the top to the bottom, and a fluid-bed drying method that dries the coal while the high-temperature dry gas is lifted up while accompanying minute particles are primarily used.

The coal is divided into surface moisture attached to a porosity between the coal particles and coupling moisture coupled to air holes in the coal. As the surface moisture, most moisture sprayed during a washing process, and transport and storage in a district and the amount of the surface moisture is determined according to a surface area and absorptiveness and as the particles are smaller, the surface area increases and a capillary is formed between the particles to contain the moisture, thereby increasing the moisture content. The coupling moisture is formed at a generation time of the coal and the amount of the coupling moisture is the smaller in the order of brown coal, soft coal (bituminous coal and subbituminous coal), and anthracite coal. When the coal has much moisture, the caloric value decreases and transport cost increases, and as a result, controlling the moisture is required during processes such as mixture, pulverization, separation, and the like of the coal.

Moreover, in a multi-stage dryer, that is, a device that dries the coal by spaying high-temperature reheat stream below a dryer while transporting the pulverized coal through a conveyor with a plurality of through-holes through which reheat steam passes or a plurality of coupled transport plates, the coal may be spontaneously ignited while the coal is transported.

General spontaneous ignition is a phenomenon in which a material placed in the air spontaneously generates heat at room temperature to be ignited and combusted. The spontaneous ignition is caused by oxidation heat, decomposition heat, adsorption heat, polymerization heat, and fermentation heat of the material and the spontaneous ignition occurs by accumulating reaction heat by oxidation, decomposition or adsorption. The spontaneous ignition is caused by the heat generated by absorption and in activated carbon, charcoal, ore, and the like, an example thereof may be found. A fracture surface of coal, sulfide ore, or the like has an oxidation property by absorbing oxygen in air to generate heat and accordingly, when the heat is not cooled, the temperature gradually increases to absorb oxygen and thus spontaneous ignition occurs. The spontaneous ignition phenomenon may be often shown in not only in the mine, but also a coal yard or an ointment storage outside the mine. Spontaneous ignition in the mine is caused by mine fire, full of toxic gas, and the like and particularly, in the coal mine, gas explosion may be caused and thus prevention thereof is very important in safety management.

Accordingly, a possibility that spontaneous ignition occurs in coal dried when supplying and transferring pulverized coal for drying the coal is increased. That is, before drying the coal, a predetermined amount of moisture is contained in the coal and thus the risk of ignition is low, but after the coal is dried through a multi-stage dryer, the coal is oxidized by absorbing oxygen in air and thus a possibility of spontaneous ignition is increased, and as result, there is a problem in safety management of the apparatus for drying coal.

As the prior art related with the present invention, in Korean Patent Registration No. 10-0960793, in a low-grade coal stabilization device, a wave-type oscillating flow plate for uniformly mixing primarily dried low-grade coal with heavy oil powder input for increasing dry efficiency is provided. The oscillating flow plate may evenly mix the low-grade coal and the heavy oil powder and there is a problem in that dried steam for drying the coal is not uniformly injected on the coal surface and thus dry efficiency may be decreased.

### DISCLOSURE

### Technical Problem

An embodiment of the present invention is directed to dry coal and prevent spontaneous ignition of coal by mixing saturated steam and/or nitrogen with reheat stream at a predetermined ratio and injecting the mixture to the coal in the apparatus for drying coal dried with reheat steam while coal used as fuel of a thermal power plant is transferred to a multi-stage dryer, improve dry efficiency of coal by loading, transferring, rotating, and dropping coal pile on a plurality of transfer plates to smoothly perform the operation of the transfer plates, and improve a dry function of the apparatus for drying coal by minimizing occurrence of dust while the coal is transferred by small-sizing the apparatus for drying coal.

Another embodiment of the present invention is directed to reduce fuel consumption by maintaining the optimum water content of coal due to effective drying of coal to enhance a calorific value of coal and improving combustion efficiency of boiler of the thermal power plant.

Yet another embodiment of the present invention is directed to provide a drying technology to prevent environmental problems due to incomplete combustion of coal by controlling moisture contained in coal and a technology applied to the thermal power plant.

### Technical Solution

According to an aspect of the present invention, there is provided an apparatus for preventing spontaneous ignition of transferred coal in an apparatus for drying coal using reheat steam, the apparatus including: a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain; and a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain, in which in the apparatus for drying coal using reheat steam, the apparatus being configured so that coal which has been dried primarily in the first coal dryer is inputted into the second coal dryer and thus is secondarily dried, reheat steam generated from a reheater is supplied through a reheat steam supply pipe, a nitrogen supplier supplies nitrogen through a nitrogen supply pipe, saturated steam generated from a saturated steam generator is supplied through a saturated steam supply pipe, and the reheat steam supply pipe, the nitrogen supplier, and the saturated steam supply pipe are connected to a 4-way valve, and the 4-way valve supplies nitrogen and saturated steam, or nitrogen or saturated steam, along with reheat steam, to first to fourth steam chambers through the steam supply pipe, and injects steam into coal which is transferred to the first transfer plate and the second transfer plate so that spontaneous ignition of coal is prevented in the course of drying and transferring coal.

Further, in the present invention, the 4-way valve may supply reheat steam and nitrogen at a predetermined ratio, supply reheat steam and saturated steam at a predetermined ratio, or supply reheat steam, nitrogen and saturated steam at a predetermined ratio by an automatic or manual operation.

Further, in the present invention, the nitrogen supplier may supply nitrogen through a second nitrogen supply pipe, the saturated steam generated from the saturated steam generator may be supplied through a second saturated steam supply pipe, the second nitrogen supply pipe and the second saturated steam supply pipe may be connected to a 3-way valve, and the 3-way valve may supply nitrogen and saturated steam, or nitrogen or saturated steam to a plurality of injection nozzles through a gas supply pipe, and inject the steam into coal which is transferred to the first transfer plate and the second transfer plate so that spontaneous ignition of coal is prevented in the course of drying and transferring coal.

Further, in the present invention, the 3-way valve may supply nitrogen and saturated steam at a predetermined ratio, or supply nitrogen or saturated steam at a predetermined ratio by an automatic or manual operation.

Further, in the present invention, the injection nozzles may be installed at the front side and rear side of the first exhaust gas chamber to the fourth exhaust gas chamber, respectively.

Further, in the present invention, first transfer rollers may be hinge-coupled between two-side centers of the first transfer plate and the first chains, respectively, at left and right sides of the first transfer roller, first auxiliary rollers may be hinge-coupled with the sides of the first transfer plate, respectively, second transfer rollers may be hinge-coupled between two-side centers of the second transfer plate and the second chains, respectively, at left and right sides of the second transfer roller, second auxiliary rollers may be hinge-coupled with the sides of the second transfer plate, respectively, a first guide bar rotating and up-supporting the lower first transfer plate separated from the second guide rail in one direction may be installed from the top to the bottom of the first drive sprocket along the side, a second guide bar rotating and down-supporting the upper first transfer plate separated from the first guide rail in one direction may be installed from the bottom to the top of the second driven sprocket along the side, a third guide bar rotating and up-supporting the lower second transfer plate separated from the fourth guide rail in one direction may be installed from the top to the bottom of the second drive sprocket along the side, a fourth guide bar rotating and down-supporting the upper second transfer plate separated from the third guide rail in one direction may be installed from the bottom to the top of the second driven sprocket along the side, and a fixed quantity coal supplier may supply a predetermined amount of coal on the surface facing the top of the first transfer plate

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

According to the present invention, it is possible to maximize usage of the apparatus for drying coal by preventing ignition or spontaneous ignition of coal that may be generated when the coal is dried or transferred in the apparatus for drying coal using reheat steam, improve dry efficiency of coal by loading, transferring, rotating, and dropping coal pile on a plurality of transfer plates to smoothly perform the operation of the transfer plates, minimizing occurrence of dust while the coal is transferred by small-sizing the apparatus for drying coal to improve reliability according to the operation of the apparatus for drying coal, prevent incomplete combustion of coal by removing moisture that remains at the inside and outside of the coal as used fuel of a thermal power plant by efficiently drying hot reheat steam to easily contact the coal particles with the hot reheat steam injected through a plurality of through-holes to the transfer plate while transferring coal pile on the plurality of transfer plates to remove the moisture included in the coal, and improve stability of coal supply by improving a caloric value of coal and minimizing emission of pollutants, reducing spontaneous ignition rate according to reduction in moisture of the coal, and enhancing utilization of low-grade coal with low demand. Further, it is possible to use low calorific coal which is cheaper than high calorific coal, reduce fuel costs and costs due to reduction in coal import amount, and reduce emission of waste and pollutants generated from exhaust gas and reduce carbon dioxide by relatively decreasing coal consumption.

### BRIEF DESCRIPTION OF THE DRAWINGS

FIG. 1 is a block diagram illustrating an apparatus for drying coal using reheat steam including an apparatus for preventing spontaneous ignition of transferred coal according to the present invention.

FIG. 2 is a configuration diagram illustrating a front side of the apparatus for drying coal using reheat steam, as a first embodiment of the present invention.

FIG. 3 is a configuration diagram illustrating a side of the apparatus for drying coal using reheat steam, as the first embodiment of the present invention.

FIGS. 4 and 5 are block diagrams illustrating the apparatus for preventing spontaneous ignition of transferred coal in the apparatus for drying coal using reheat steam according to the present invention.

FIG. 6 is a perspective view illustrating a main part installed with the apparatus for preventing spontaneous ignition of transferred coal in the apparatus for drying coal using reheat steam according to the present invention.

FIG. 7 is a configuration diagram illustrating a front side of the apparatus for drying coal using reheat steam, as a second embodiment of the present invention.

FIG. 8 is a perspective view illustrating a main part installed with the apparatus for preventing spontaneous ignition of transferred coal in the apparatus for drying coal using reheat steam according to the present invention.

FIG. 9 is a perspective view illustrating a main part in the apparatus for drying coal using reheat steam according to the present invention.

FIG. 10 is a separated perspective view illustrating a main part of a transfer device in the apparatus for drying coal using reheat steam according to the present invention.

FIGS. 11 and 12 are cross-sectional views illustrating an operation of the transfer device in the apparatus for drying coal using reheat steam according to the present invention, respectively.

### BEST MODE FOR THE INVENTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, an apparatus for preventing spontaneous ignition of transferred coal for drying in an apparatus for drying coal using reheat steam will be described in detail with reference to the accompanying drawings.

The apparatus for preventing spontaneous ignition of transferred coal of the present invention is installed in the apparatus for drying coal, and a fixed quantity coal supplier in the apparatus for drying coal mixes and injects nitrogen containing hot reheat steam and saturated steam at a predetermined ratio while supplying and transferring coal to a transfer device such as a conveyor or a transfer plate, mixes and injects nitrogen containing reheat steam at a predetermined ratio, or mixes and injects saturated steam containing reheat steam at a predetermined ratio to prevent spontaneous ignition of coal dried when drying the coal. Further, while the coal is transferred to the transfer device such as the conveyor or the transfer plate in the apparatus for drying coal, nitrogen and/or saturated steam is mixed at a predetermined ratio and injected on the coal surface to prevent spontaneous ignition of coal.

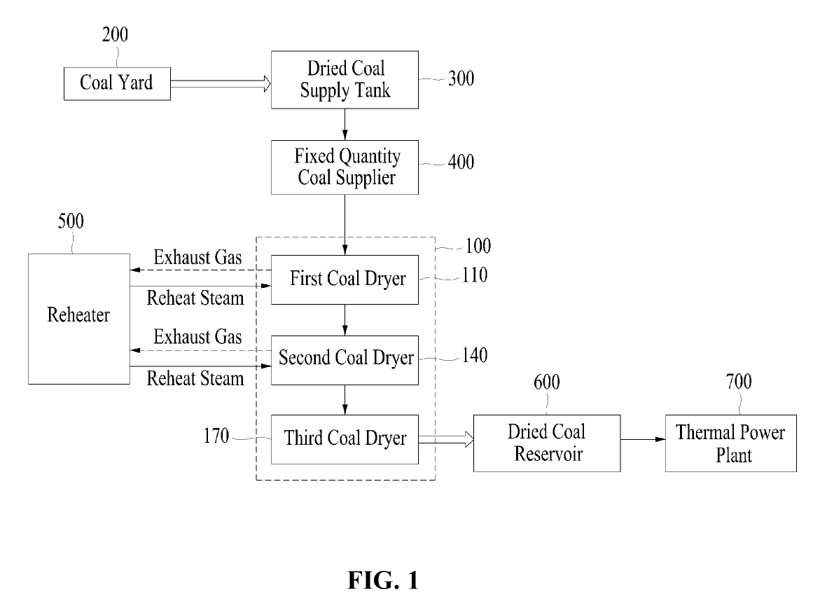

In FIG. 1, a coal yard 200 keeps and stores coal used as boiler fuel of a thermal power plant. The coal contains surface moisture and internal moisture. Further, the coal stored in the coal yard 200 is sprayed with water to prevent scattering of coal dust. The coal stored in the coal yard 200 is transferred to the apparatus for drying coal 100 through a transfer means such as a conveyor system. In this case, the coal in the coal yard 200 without removing the moisture may be transferred and stored to a coal supply tank 300 for dying connected with the apparatus for drying coal. In addition, the coal stored in the coal supply tank 300 is supplied to the apparatus for drying coal 100 from the fixed quantity coal supplier 400 with a predetermined amount. The apparatus for drying coal 100 includes a first coal dryer 110 installed in multiple layers and a third coal dryer 170 for naturally drying the coal discharged through a second coal dryer 140. The first coal dryer 110 and the second coal dryer 140 have substantially the same structure. The coal naturally dried through the third coal dryer 170 is stored in a dried coal reservoir 600 and then supplied as boiler fuel of a thermal power plant 700.

Further, nitrogen supplied from a nitrogen supplier 800 and saturated steam generated in a saturated steam generator 900 are supplied to the first coal dryer 110 and the second coal drier 140 of the apparatus for drying coal 100.

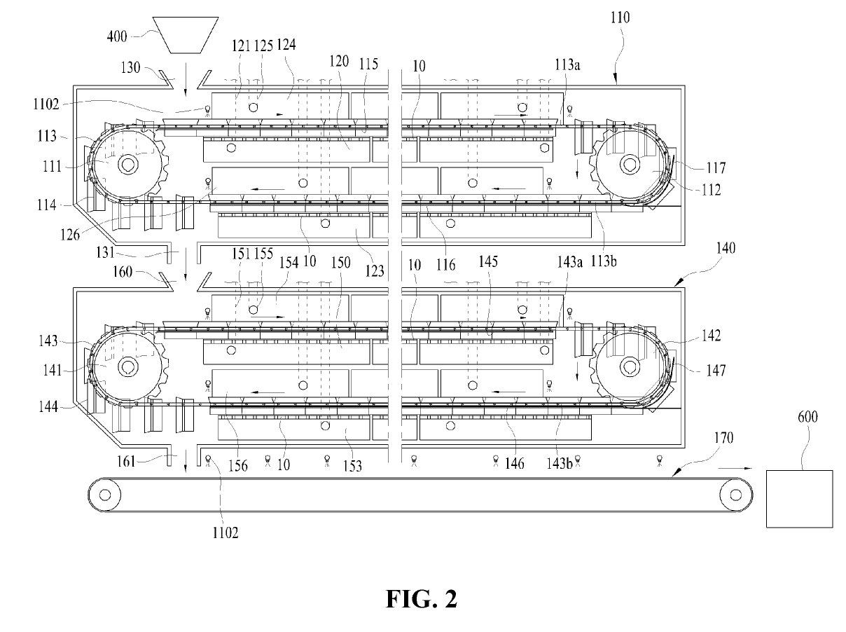

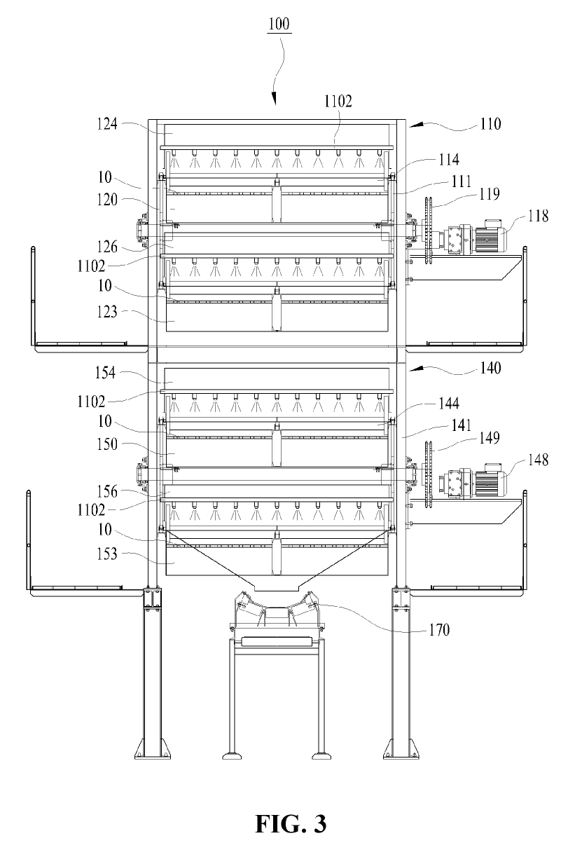

FIGS. 2 and 3 illustrate an example of the apparatus for drying coal 100 installed with the apparatus for preventing spontaneous ignition of transferred coal according to the present invention. The apparatus for drying coal 100 includes a multi-stage dryer, that is, the first coal dryer 110 drying the coal input from the fixed quantity coal supplier 400, the second coal dryer 140 secondarily drying the coal dried in the first coal dryer, and the third coal dryer 170 naturally drying the coal dried in the second coal dryer and then supplying the dried coal to a dried coal reservoir 50.

In the first coal dryer 110, a pair of first drive sprockets 111 and a pair of first driven sprockets 112 are spaced apart from each other at a predetermined distance to be fastened to first chains 113, respectively, a plurality of transfer plates 114 is hinge-coupled between the first chains 113, a pair of first guide rails 115 horizontally supporting the first transfer plate 114 is installed below an upper second chain 143 connected between the first drive sprocket 111 and the first driven sprocket 112, a pair of second guide rails 116 horizontally supporting the first transfer plate 114 is installed below a lower first chain 113 connected between the first drive sprocket 111 and the first driven sprocket 112, a first steam chamber 120 injecting reheat steam supplied from a reheater 500 is installed below the upper first chain 113, a second steam chamber 123 injecting reheat steam supplied from the reheater 500 is installed below the lower first chain 113, a first exhaust gas chamber 124 collecting exhaust gas is installed on the upper first chain 113, and a second exhaust gas chamber 126 collecting exhaust gas is installed on the lower first chain 113.

In addition, in the second coal dryer 140, a pair of second drive sprockets 141 and a pair of second driven sprockets 142 are spaced apart from each other at a predetermined distance to be fastened to second chains 143, respectively, a plurality of transfer plates 144 is hinge-coupled between the second chains 143, a pair of second guide rails 145 horizontally supporting the second transfer plate 144 is installed below an upper second chain 143 connected between the second drive sprocket 141 and the second driven sprocket 142, a pair of second guide rails 146 horizontally supporting the second transfer plate 144 is installed below a lower second chain 143 connected between the second drive sprocket 141 and the second driven sprocket 142, a third steam chamber 150 injecting reheat steam supplied from the reheater 500 is installed below the upper second chain 143, a fourth steam chamber 153 injecting reheat steam supplied from the reheater 500 is installed below the lower second chain 143, a third exhaust gas chamber 154 collecting exhaust gas is installed on the upper second chain 143, and a fourth exhaust gas chamber 156 collecting exhaust gas is installed on the lower second chain 143.

In addition, in the first transfer plate 114, a plurality of through-holes 114a is formed so that the reheat steam injected from the first steam chamber 120 and the second steam chamber 123 passes through the first transfer plate 114 to contact coal particles. At upper left and right sides of the first transfer plate 114, guards 114b having predetermined heights are installed to prevent the input coal pile from flowing in a left or right direction of the first transfer plate 114. The guard 114b has a shape that is narrow at the top and widened at the bottom as a substantially trapezoidal shape. Accordingly, the top of the guard 114b of the first transfer plate 114 is overlapped with an adjacent guard 114b. In this case, the guard 114b of the first transfer plate 114 may be installed in a substantially zigzag direction with the adjacent guard 114b. Further, at lower left and right sides of the first transfer plate 114, shield plates 114c are installed to prevent the reheat steam injected from the first steam chamber 120 and the second steam chamber 123 from being lost when injected to left and right sides of each of the first steam chamber 120 and the second steam chamber 123.

In addition, in the second transfer plate 144, a plurality of through-holes 144a is formed so that the reheat steam injected from the third steam chamber 150 and the fourth steam chamber 153 passes through the second transfer plate 144 to contact coal particles. At upper left and right sides of the second transfer plate 144, guards 144b having a predetermined height are installed to prevent the input coal pile from flowing in a left or right direction of the second transfer plate 144. The guard 144b has a shape that is narrow at the top and widened at the bottom as a substantially trapezoidal shape. Accordingly, the top of the guard 144b of the second transfer plate 144 is overlapped with an adjacent guard 144b. In this case, the guard 144b of the second transfer plate 144 may be installed in a substantially zigzag direction with the adjacent guard 144b. Further, at lower left and right sides of the second transfer plate 144, shield plates 144c are installed to prevent the reheat steam injected from the third steam chamber 150 and the fourth steam chamber 153 from being lost when injected to left and right sides of each of the third steam chamber 150 and the fourth steam chamber 153.

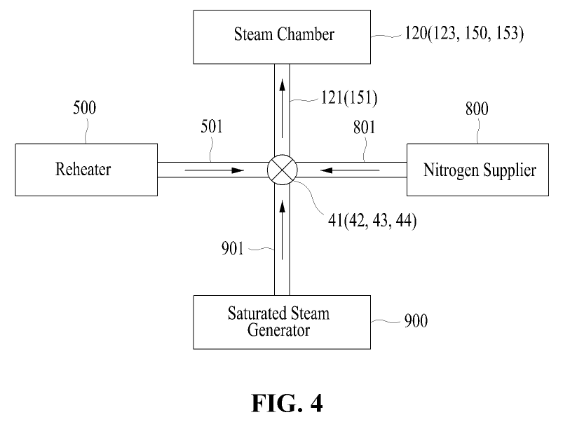

In FIG. 4, in each of the first steam chamber 120 and the second steam chamber 123 installed in the first transfer plate 114 of the first coal dryer 110, a steam supply pipe 121 is installed, and in each of the third steam chamber 150 and the fourth steam chamber 153 installed in the second transfer plate 144 of the second coal dryer 140, a steam supply pipe 151 is installed. In each of the steam supply pipes 121 and 151, a 4-way valve 1000 is installed. The 4-way valve 1000 controls the flow of fluid in four directions.

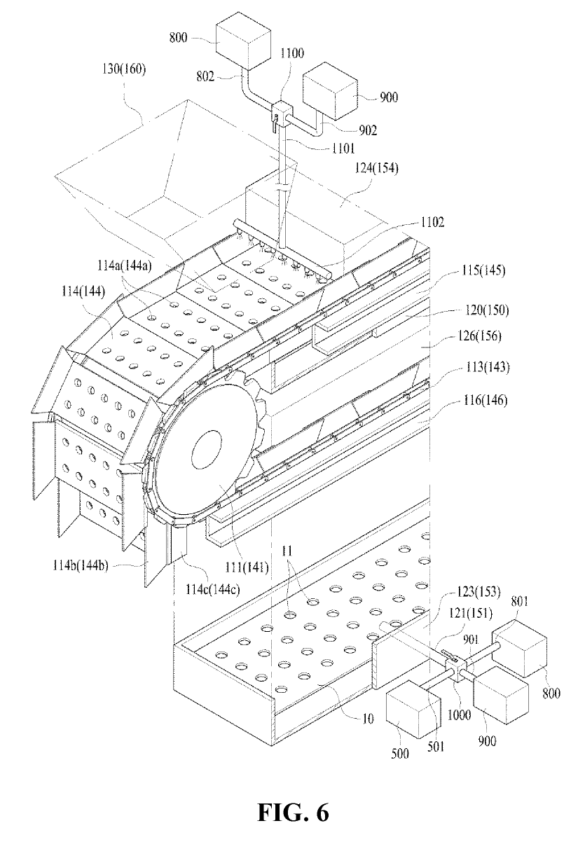

In FIG. 6, in the 4-way valve 1000, a reheat steam supply pipe 501 supplying the reheat steam generated in the reheater 500 is installed. The reheater 500 receives exhaust gas discharged from the first to fourth exhaust gas chambers 124, 126, 154, and 156 corresponding to the first to fourth steam chambers 120, 123, 150, and 153 to regenerate and supply the received gas as reheat steam. In the 4-way valve 1000, a nitrogen supply pipe 801 supplying nitrogen from a nitrogen supplier 800 is installed. The nitrogen supplier 800 may include a device of supplying nitrogen from a storage tank that stores liquefied nitrogen or collecting and supplying nitrogen in air. Further, in the 4-way valve 1000, a saturated steam supply pipe 901 supplying saturated steam from a saturated steam generator 900 is installed. The saturated steam generated from saturated steam generator 900 is hot and humid steam containing more than a predetermined amount of moisture and the reheat steam generated from the reheater 500 is hot and dried steam containing more than a predetermined amount of moisture.

Accordingly, in the 4-way valve 1000, the reheat steam, nitrogen, and the saturated steam received from the reheater 500, the nitrogen supplier 800, and the saturated steam generator 900 through the reheat steam supply pipe 501, the nitrogen supply pipe 801, and the saturated steam supply pipe 901 are supplied to the corresponding steam chambers 120, 123, 150, and 153 through the steam supply pipes 121 and 151, respectively. The 4-way valve 1000 may supply only any one of the reheat steam, nitrogen, and the saturated steam to the steam chambers 120, 123, 150, and 153 through the steam supply pipes 121 and 151 according to a manual or automatic operation of the valve. Further, the 4-way valve 1000 may supply nitrogen or saturated steam containing reheat steam to the steam chambers 120, 123, 150, and 153 through the steam supply pipes 121 and 151 at a predetermined ratio according to a manual or automatic operation of the valve. Preferably, the 4-way valve 1000 may be operated to supply reheat steam and nitrogen, reheat steam and saturated steam, or reheat steam, nitrogen, and saturated steam at a predetermined ratio. The reason is that in the case where transferred coal loaded on the transfer plate is dried with hot and dried reheat steam, when moisture contained in the inside and on the surface of the coal is fully evaporated, a possibility that spontaneous ignition occurs while the coal is transferred may be increased.

Therefore, the apparatus for preventing spontaneous ignition of transferred coal in the apparatus for drying coal injects nitrogen mixed in the reheat steam with a predetermined amount to the transferred coal by the operation of the 4-way valve 1000 installed in the steam supply pipes 121 and 151 connected to the steam chambers 120, 123, 150, and 153 to dry the coal and prevent oxygen from being in contact with the coal particles, thereby preventing oxidation of the coal to prevent spontaneous ignition.

Further, saturated steam mixed in the reheat steam with a predetermined amount is injected to the transferred coal by the operation of the 4-way valve 1000 installed in the steam supply pipes 121 and 151 connected to the steam chambers 120, 123, 150, and 153 to dry the coal and saturated steam containing a predetermined amount of moisture is injected to the coal to provide a minimal amount of moisture without causing spontaneous ignition to the coal particles.

Further, nitrogen and saturated steam mixed in the reheat steam with a predetermined amount is injected to the coal by the operation of the 4-way valve 1000 installed in the steam supply pipes 121 and 151 connected to the steam chambers 120, 123, 150, and 153 to prevent oxygen from being in contact with the coal particles and provide a minimal amount of moisture without causing spontaneous ignition to the coal particles.

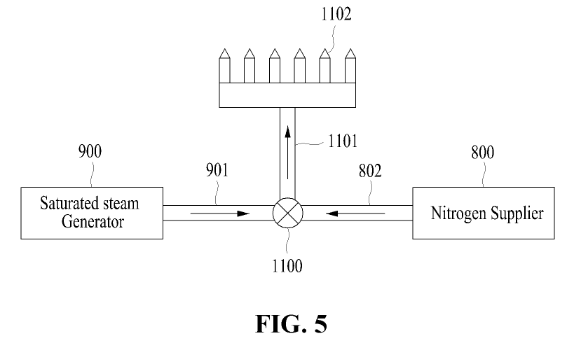

In FIG. 5, a second nitrogen supply pipe 802 supplying nitrogen is installed in the nitrogen supplier 800 and a second saturated steam supply pipe 902 supplying saturated steam is installed in the saturated steam generator 900. In addition, the second nitrogen supply pipe 802 and the second saturated steam supply pipe 902 are connected to a 3-way valve 1000. The 3-way valve 1000 supplies nitrogen and saturated steam, nitrogen or saturated steam to a plurality of injection nozzles 1102 through a gas supply pipe 1101.

The 3-way valve 1000 supplies nitrogen and saturated steam at a predetermined ratio by an automatic or manual operation or supplies nitrogen or saturated steam at a predetermined ratio.

Further, the injection nozzles 1102 are installed at the front side and the rear side of the first to fourth flue gas chambers 124, 126, 154, and 156 to inject nitrogen and/or saturated steam on the coal surface before or after drying the reheat steam on the first transfer plate 114 and the second transfer plate 144, thereby preventing spontaneous ignition of coal.

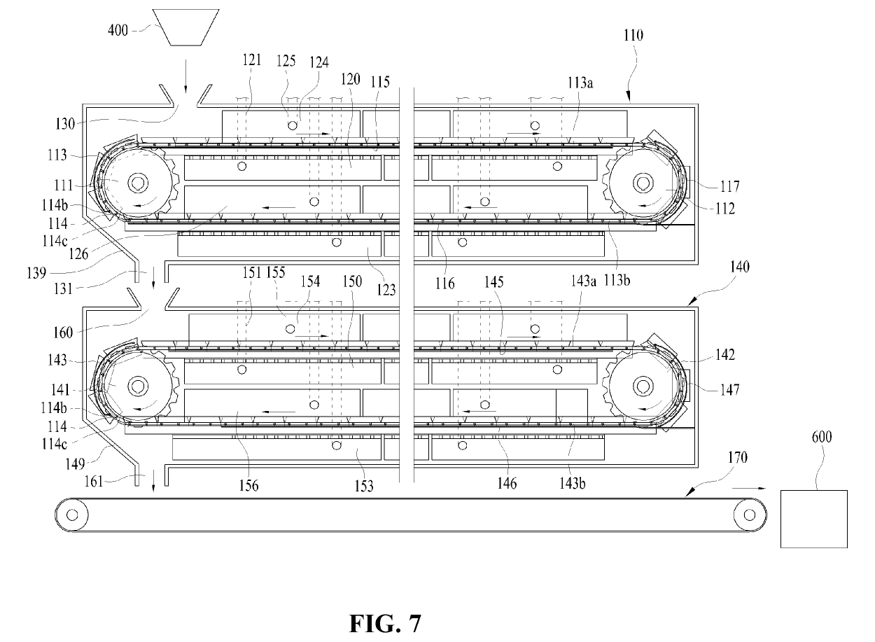

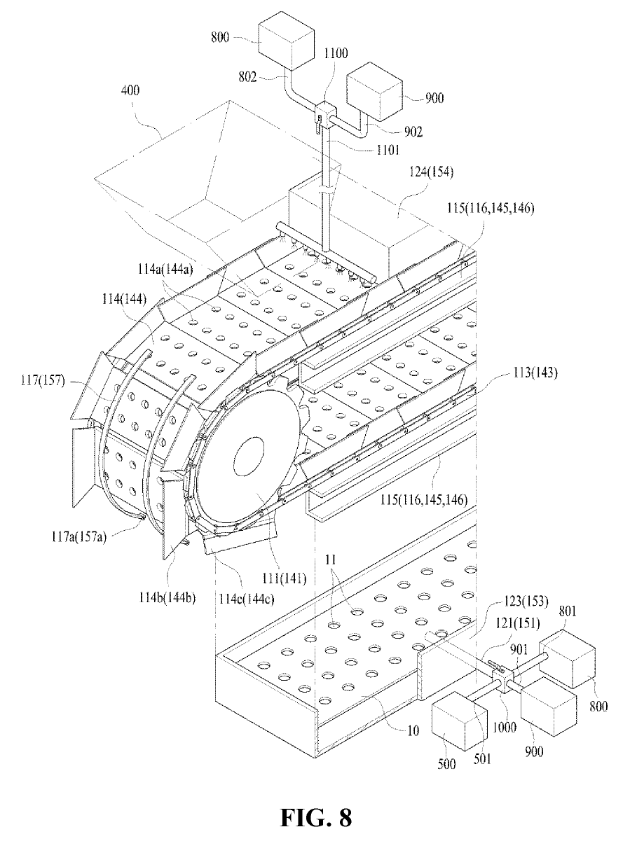

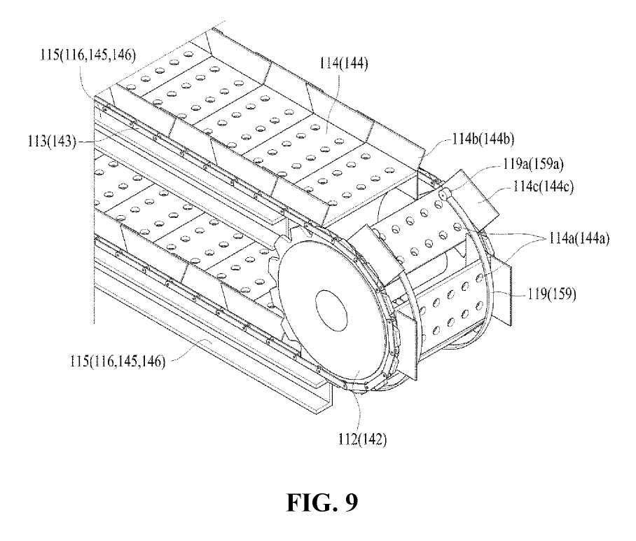

As another example of the present invention, in FIGS. 7 to 12, an apparatus for preventing spontaneous ignition of transferred coal in an apparatus for drying coal using reheat steam is applied.

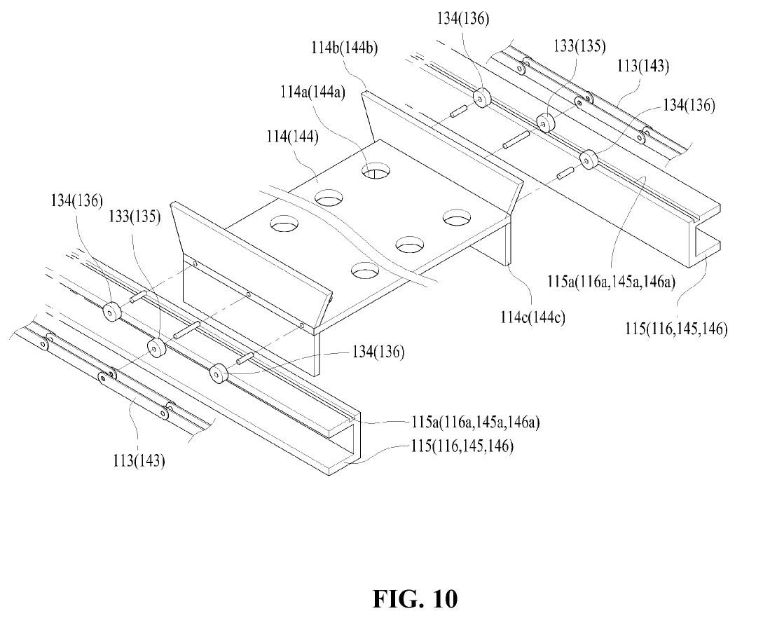

In FIG. 10, a second transfer roller 135 is hinge-coupled between two-side centers of the second transfer plate 144 and the second chains 113. That is, the second transfer roller 135 is hinge-coupled between the lateral center of the second transfer plate 144 and the second chain 143. In addition, at left and right sides of the second transfer roller 135, second auxiliary rollers 136 are hinge-coupled with the sides of the second transfer plate 144, respectively. The second auxiliary rollers 136 are hinge-coupled with the sides of the second transfer plate 144, that is, the left side and the right side.

Further, a groove 145a and a groove 146a guiding rotation of the second transfer roller 135 and the second auxiliary roller 136 are formed on the surfaces of the third guide rail 145 and the fourth guide rail 146, respectively. Accordingly, the second transfer roller 135 and the second auxiliary roller 136 hinge-coupled with the second transfer plate 144 is transferred along the groove 145a formed on the surface of the third guide rail 145 and the groove 146a formed on the surface of the fourth guide rail 146.

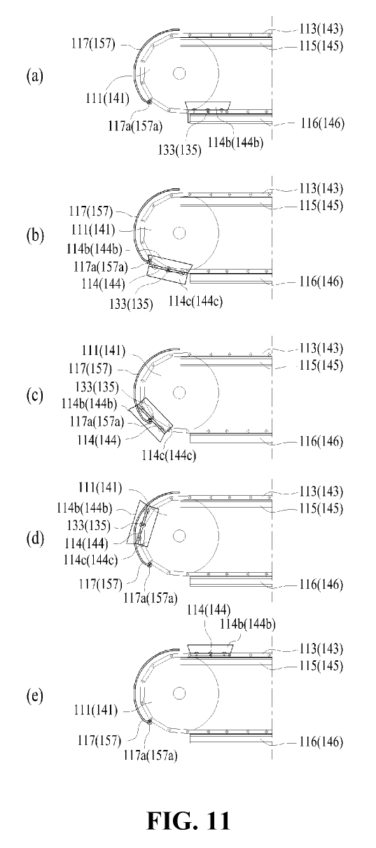

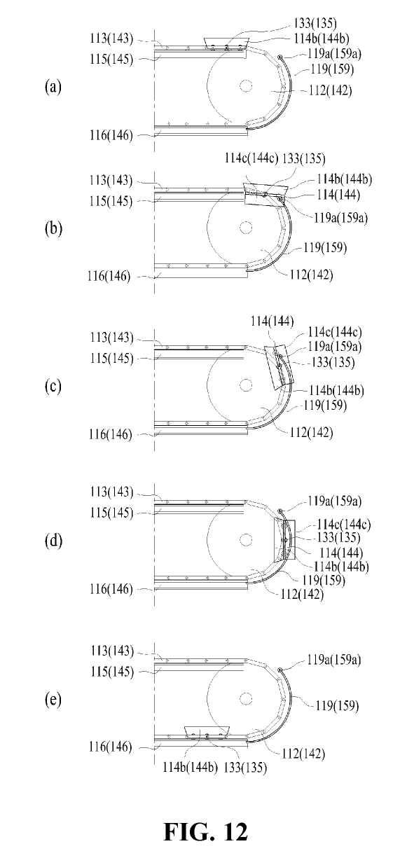

Meanwhile, in FIGS. 11 and 12, a third guide bar 157 rotating and up-supporting the lower second transfer plate 144 separated from the fourth guide rail 146 in one direction is installed from the top to the bottom of the second drive sprocket 141 along the side. A third trigger 157a is coupled to the end of a third guide bar 157 and the third trigger 157a is constituted by an axial rotating roller. The third trigger 157a is installed at a position which is in contact with a lower side of the upper second transfer plate 144.

Further, a fourth guide bar 159 rotating and down-supporting the upper second transfer plate 144 separated from the third guide rail 145 is installed from the bottom to the top of the second driven sprocket 142 along the side. A fourth trigger 159a is coupled to the end of a fourth guide bar 159 and the fourth trigger 159a is constituted by an axial rotating roller. The fourth trigger 159a is installed at a position which is in contact with a planar side of the lower second transfer plate 144.

In addition, in the first transfer plate 114, a plurality of through-holes 114a is formed so that the reheat steam injected from the first steam chamber 120 and the second steam chamber 123 passes through the first transfer plate 114 to contact coal particles. At upper left and right sides of the first transfer plate 114, a guard 114b having a predetermined height is installed to prevent the input coal pile from flowing in a left or right direction of the first transfer plate 114. The guard 114b has a shape that is narrow at the top and widened at the bottom as a substantially trapezoidal shape. Accordingly, the top of the guard 114b of the first transfer plate 114 is overlapped with an adjacent guard 114b. In this case, the guard 114b of the first transfer plate 114 is installed in a substantially zigzag direction with the adjacent guard 114b. Further, at lower left and right sides of the first transfer plate 114, shield plates 114c are installed to prevent the reheat steam injected from the first steam chamber 120 and the second steam chamber 123 from being lost when injected to left and right sides of each of the first steam chamber 120 and the second steam chamber 123.

In addition, in the second transfer plate 144, a plurality of through-holes 144a is formed so that the reheat steam injected from the third steam chamber 150 and the fourth steam chamber 153 passes through the second transfer plate 144 to contact coal particles. At upper left and right sides of the second transfer plate 144, guards 144b having a predetermined height are installed to prevent the input coal pile from flowing in a left or right direction of the second transfer plate 144. The guard 144b has a shape that is narrow at the top and widened at the bottom as a substantially trapezoidal shape. Accordingly, the top of the guard 144b of the second transfer plate 144 is overlapped with an adjacent guard 144b. In this case, the guard 144b of the second transfer plate 144 may be installed in a substantially zigzag direction with the adjacent guard 144b. Further, at lower left and right sides of the second transfer plate 144, shield plates 144c are installed to prevent the reheat steam injected from the third steam chamber 150 and the fourth steam chamber 153 from being lost when injected to left and right sides of each of the third steam chamber 150 and the fourth steam chamber 153.

In addition, in FIG. 12A, the upper first transfer plate 114 is transferred to the end of the first guide rail 115 by rotating the first driven sprocket 112. In FIG. 12B, while the lower left side of the upper first transfer plate 114 deviates from the end of the first guide rail 115, the lower right side of the upper first transfer plate 114 is in contact with the second trigger 119a of the second guide bar 119. In this case, in the upper first chain 113, the upper first transfer plate 114 hinge-coupled to the first transfer roller 133 is separated from the first guide rail 115 and simultaneously rotates in a left direction of the first transfer roller 133 as an axis to drop down the loaded coal pile. In addition, in FIG. 12C, the bottom of the upper first transfer plate 114 moves downward along the second trigger 119a. In FIG. 12D, the upper first transfer plate 114 is maintained in a substantially vertical state and moves without pivoting along a rotation radius of the first drive sprocket 112 while the bottom contacts the second guide bar 119. In FIG. 12E, while the upper first transfer plate 114 transferred downward moves up to the second guide rail 116, the coal pile dropped down from the first transfer plate along the lower first transfer plate 114 is loaded and transferred. In addition, the coal pile loaded on the lower first transfer plate 114 is transferred and dried by the reheat steam.

Next, in FIG. 11A, the lower first transfer plate 114 is transferred to the end of the second guide rail 116 by rotating the first drive sprocket 111. In FIG. 11B, while the lower right side of the lower first transfer plate 114 deviates from the end of the second guide rail 116, the planar left side of the lower first transfer plate 114 is in contact with the first trigger 117a of the first guide bar 117. In this case, in the lower first chain 113, the lower first transfer plate 114 hinge-coupled to the first transfer roller 133 is separated from the second guide rail 116 and simultaneously rotates in a left direction of the first transfer roller 133 as an axis to drop down the loaded coal pile. In addition, in FIG. 11C, the plane of the upper first transfer plate 114 moves upward along the first trigger 117a. In FIG. 11D, the lower first transfer plate 114 is maintained in a substantially vertical state and moves without pivoting along a rotation radius of the first drive sprocket 111 while the plane contacts the first guide bar 117. In FIG. 11E, while the lower first transfer plate 114 transferred upward moves up to the first guide rail 115, the coal pile input from the fixed quantity coal supplier 400 with a predetermined amount along the upper first transfer plate 114 is loaded and transferred. In addition, the coal pile loaded on the upper first transfer plate 114 is transferred and dried by the reheat steam. The coal pile dropped from the lower first transfer plate 114 is discharged to an outlet 131 along a first slope 139.

Further, the coal pile dropped from the first coal dryer 110 to the outlet 131 is input to an inlet 160 of the second coal dryer 140, input on the surface of the second transfer plate 144 of the second coal dryer 140, and then transferred. In addition, the coal pile loaded on the upper second transfer plate 144 is transferred and dried by the reheat steam.

The transfer process of coal in the second coal dryer 140 is the same as the transfer process of the first coal dryer 110. In addition, the coal pile dropped from the lower second transfer plate 144 is discharged to an outlet 161 along a second slope 149. In addition, the coal pile dropped from the second coal dryer 140 to the outlet 161 is naturally dried while supplied and transferred to the third coal dryer 170.

In the present invention, the steam supply pipe 121 supplying hot reheat steam generated from the reheater 500 is connected to one side of the first steam chamber 120 and the second steam chamber 123, and the steam supply pipe 151 supplying hot reheat steam generated from the reheater 500 is connected to one side of the third steam chamber 150 and the fourth steam chamber 153. In addition, a perforated plate 10 for first steam distribution through-formed with a plurality of first steam injection holes 11 is installed on the inside of each of the first steam chamber 120, the second steam chamber 123, the third steam chamber 150, and the fourth steam chamber 153. In each of the first steam chamber 120 to the fourth steam chamber 153, the reheat stream having uniform pressure is injected through the first steam injection holes 11.

In FIG. 4, in each of the first steam chamber 120 and the second steam chamber 123 installed in the first transfer plate 114 of the first coal dryer 110, a steam supply pipe 121 is installed, and in each of the third steam chamber 150 and the fourth steam chamber 153 installed in the second transfer plate 144 of the second coal dryer 140, a steam supply pipe 151 is installed. In each of the steam supply pipes 121 and 151, a 4-way valve 1000 is installed. The 4-way valve 1000 controls the flow of fluid in four directions.

Further, in the 4-way valve 1000, a reheat steam supply pipe 501 supplying the reheat steam generated in the reheater 500 is installed. The reheater 500 receives exhaust gas discharged from the first to fourth exhaust gas chambers 124, 126, 154, and 156 corresponding to the first to fourth steam chambers 120, 123, 150, and 153 to regenerate and supply the received gas as reheat steam. In the 4-way valve 1000, a nitrogen supply pipe 801 supplying nitrogen from a nitrogen supplier 800 is installed. The nitrogen supplier 800 may include a device of supplying nitrogen from a storage tank that stores liquefied nitrogen or collecting and supplying nitrogen in air. Further, in the 4-way valve 1000, a saturated steam supply pipe 901 supplying saturated steam from a saturated steam generator 900 is installed. The saturated steam generated from saturated steam generator 900 is hot and humid steam containing more than a predetermined amount of moisture and the reheat steam generated from the reheater 500 is hot and dried steam containing more than a predetermined amount of moisture.

Accordingly, in the 4-way valve 1000, the reheat steam, nitrogen, and the saturated steam received from the reheater 500, the nitrogen supplier 800, and the saturated steam generator 900 through the reheat steam supply pipe 501, the nitrogen supply pipe 801, and the saturated steam supply pipe 901 are supplied to the corresponding steam chambers 120, 123, 150, and 153 through the steam supply pipes 121 and 151, respectively. The 4-way valve 1000 may supply only any one of the reheat steam, nitrogen, and the saturated steam to the steam chambers 120, 123, 150, and 153 through the steam supply pipes 121 and 151 according to a manual or automatic operation of the valve. Further, the 4-way valve 1000 may supply nitrogen or saturated steam containing reheat steam to the steam chambers 120, 123, 150, and 153 through the steam supply pipes 121 and 151 at a predetermined ratio according to a manual or automatic operation of the valve. Preferably, the 4-way valve 1000 may be operated to supply reheat steam and nitrogen, reheat steam and saturated steam, or reheat steam, nitrogen, and saturated steam at a predetermined ratio. The reason is that in the case where transferred coal loaded on the transfer plate is dried with hot and dried reheat steam, when moisture contained in the inside and on the surface of the coal is fully evaporated, a possibility that spontaneous ignition occurs while the coal is transferred may be increased.

Therefore, the apparatus for preventing spontaneous ignition of transferred coal in the apparatus for drying coal injects nitrogen mixed in the reheat steam with a predetermined amount to the transferred coal by the operation of the 4-way valve 1000 installed in the steam supply pipes 121 and 151 connected to the steam chambers 120, 123, 150, and 153 to dry the coal and prevent oxygen from being in contact with the coal particles, thereby preventing oxidation of the coal to prevent spontaneous ignition.

Further, saturated steam mixed in the reheat steam with a predetermined amount is injected to the transferred coal by the operation of the 4-way valve 1000 installed in the steam supply pipes 121 and 151 connected to the steam chambers 120, 123, 150, and 153 to dry the coal and saturated steam containing a predetermined amount of moisture is injected to the coal to provide a minimal amount of moisture without causing spontaneous ignition to the coal particles.

Further, nitrogen and saturated steam mixed in the reheat steam with a predetermined amount is injected to the coal by the operation of the 4-way valve 1000 installed in the steam supply pipes 121 and 151 connected to the steam chambers 120, 123, 150, and 153 to prevent oxygen from being in contact with the coal particles and provide a minimal amount of moisture without causing spontaneous ignition to the coal particles.

Accordingly, the apparatus for preventing spontaneous ignition of transferred coal in the apparatus for drying coal has advantages of drying the coal and preventing spontaneous ignition by supplying reheat stream and nitrogen or saturated steam to the steam chambers 120 and 123 installed below the first transfer plate 114 and the steam chambers 150 and 153 installed below the second transfer plate 144 with a predetermined ratio to inject the reheat stream and nitrogen or saturated steam to the transferred coal on the corresponding plate, and reducing costs according to maintenance of the apparatus for drying coal as well as improving dry efficiency and preventing failure or malfunction of the apparatus for drying coal by spontaneous ignition which may be generated in the course of drying coal in the apparatus for drying coal by injecting nitrogen and saturated steam onto the coal surface transferred to the first transfer plate 114 and the second transfer plate 144 at a predetermined ratio.

While the present invention has been described with respect to the specific embodiments, it will be apparent to those skilled in the art that various changes and modifications may be made without departing from the spirit and scope of the invention as defined in the following claims.

### INDUSTRIAL AVAILABILITY

The present invention has industrial availability which can maximize usage of the apparatus for drying coal by preventing ignition or spontaneous ignition of coal that may be generated when the coal is dried or transferred in the apparatus for drying coal using reheat steam, prevent incomplete combustion of coal by removing moisture that remains at the inside and outside of the coal as used fuel of a thermal power plant, and improve stability of coal supply by improving a caloric value of coal and minimizing emission of pollutants, reducing spontaneous ignition rate according to reduction in moisture of the coal, and enhancing utilization of low-grade coal with low demand.

1. An apparatus for preventing spontaneous ignition of transferred coal in an apparatus for drying coal using reheat steam, the apparatus comprising: a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain; and
a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain,
wherein in the apparatus for drying coal using reheat steam, the apparatus being configured so that coal which has been dried primarily in the first coal dryer is inputted into the second coal dryer and thus is secondarily dried,
reheat steam generated from a reheater is supplied through a reheat steam supply pipe,
a nitrogen supplier supplies nitrogen through a nitrogen supply pipe,
saturated steam generated from a saturated steam generator is supplied through a saturated steam supply pipe, and
the reheat steam supply pipe, the nitrogen supplier, and the saturated steam supply pipe are connected to a 4-way valve, and the 4-way valve supplies nitrogen and saturated steam, or nitrogen or saturated steam, along with reheat steam, to first to fourth steam chambers through the steam supply pipe, and injects steam into coal which is transferred to the first transfer plate and the second transfer plate so that spontaneous ignition of coal is prevented in the course of drying and transferring coal.

2. The apparatus of claim 1, wherein the 4-way valve supplies reheat steam and nitrogen at a predetermined ratio, reheat steam and saturated steam at a predetermined ratio, or reheat steam, nitrogen and saturated steam at a predetermined ratio by an automatic or manual operation.

3. The apparatus of claim 1, wherein the nitrogen supplier supplies nitrogen through a second nitrogen supply pipe, the saturated steam generated from the saturated steam generator is supplied through a second saturated steam supply pipe, the second nitrogen supply pipe and the second saturated steam supply pipe are connected to a 3-way valve, and the 3-way valve supplies nitrogen and saturated steam, or nitrogen or saturated steam to a plurality of injection nozzles through a gas supply pipe, and injects the steam into coal which is transferred to the first transfer plate and the second transfer plate so that spontaneous ignition of coal is prevented in the course of drying and transferring coal.

4. The apparatus of claim 3, wherein the 3-way valve supplies nitrogen and saturated steam at a predetermined ratio, or supplies nitrogen or saturated steam at a predetermined ratio by an automatic or manual operation.

5. The apparatus of claim 3, wherein the injection nozzles are installed at the front side and rear side of the first exhaust gas chamber to the fourth exhaust gas chamber, respectively.

6. The apparatus of claim 1, wherein first transfer rollers are hinge-coupled between two-side centers of the first transfer plate and the first chains, respectively, at left and right sides of the first transfer roller, first auxiliary rollers are hinge-coupled with the sides of the first transfer plate, respectively, second transfer rollers are hinge-coupled between two-side centers of the second transfer plate and the second chains, respectively, at left and right sides of the second transfer roller, second auxiliary rollers are hinge-coupled with the sides of the second transfer plate, respectively, a first guide bar rotating and up-supporting the lower first transfer plate separated from the second guide rail in one direction is installed from the top to the bottom of the first drive sprocket along the side, a second guide bar rotating and down-supporting the upper first transfer plate separated from the first guide rail in one direction is installed from the bottom to the top of the second driven sprocket along the side, a third guide bar rotating and up-supporting the lower second transfer plate separated from the fourth guide rail in one direction is installed from the top to the bottom of the second drive sprocket along the side, a fourth guide bar rotating and down-supporting the upper second transfer plate separated from the third guide rail in one direction is installed from the bottom to the top of the second driven sprocket along the side, and a fixed quantity coal supplier supplies a predetermined amount of coal on the surface facing the top of the first transfer plate.
